(19) United States
(12) Patent Application Publication
(10) Pub. No.: US 2019/0266568 A1
(43) Pub. Date: Aug. 29, 2019

(54) BLOCKCHAIN-BASED SYSTEM AND METHOD FOR CROWDSOURCED DELIVERY

(71) Applicant: Walmart Apollo, LLC, Bentonville, AR (US)

(72) Inventors: John J. O'BRIEN, Farmington, AR (US); Robert CANTRELL, Herndon, VA (US); Brian MCHALE, Oldham (GB); Todd MATTINGLY, Bentonville, AR (US)

(73) Assignee: Walmart Apollo, LLC, Bentonville, AR (US)

(21) Appl. No.: 16/284,367

(22) Filed: Feb. 25, 2019

Related U.S. Application Data
(60) Provisional application No. 62/636,797, filed on Feb. 28, 2018.

(51) Int. Cl. G06Q 10/08; G06Q 30/00; H04L 9/06

(52) U.S. Cl. CPC G06Q 10/08355; G06Q 10/0833; H04L 2209/38; H04L 9/0637; G06Q 10/0832; G06Q 30/012

(57) ABSTRACT

A blockchain-based method includes: generating an order for a customer based on the customer's profile; receiving warranty data for the order from manufacturers; associating the order with the warranty data; generating a token for the customer and adding the token to the customer's profile; updating the token with the warranty data; determining a delivery method for the order; identifying a courier based on the determined delivery method; transferring the token to the identified courier; updating the token when the order is delivered; and paying the courier when the delivery of the order is confirmed. Transactions in each step are stored in a blockchain.

### CROSS REFERENCE TO RELATED APPLICATIONS

This present Patent Application claims priority benefit from U.S. Provisional Patent Application No. 62/636,797 filed on Feb. 28, 2018, the entire content of which is hereby incorporated herein by reference.

### BACKGROUND

### 1. Technical Field

The present disclosure relates to blockchain technology, and more specifically to a blockchain-based system and method for crowdsourced delivery.

### 2. Introduction

Blockchain is a shared and distributed ledger that may facilitate the process of recording transactions and tracking assets in a peer-to-peer network. An asset may be tangible (e.g., a house, a car, and so on). An asset may also be intangible like intellectual property (IP), such as patents, copyrights, or branding. For example, a blockchain-based supply chain system may facilitate transferring products and reduce disputes among the parties.

### SUMMARY

A method for crowdsourced delivery is provided. The method includes generating, by a first computer, an order for a customer based on a profile of the customer, wherein the profile of the customer is stored on a second computer, and the first computer communicates with the second computer to retrieve the profile of the customer; receiving, by the first computer, warranty data for the order from a computer of manufacturer of the order; associating, by the first computer, the order with the warranty data; generating, by the computer of the manufacturer of the order, a token for the customer; receiving, by the first computer, the token for the customer from the computer of the manufacturer of the order; adding, by the second computer, the token to the profile of the customer to generate an updated profile of the customer, wherein the first computer communicates with the second computer to send the token to the second computer; updating, by the first computer, the token with the warranty data; determining, by the first computer, a delivery method for the order, based on the updated profile of the customer; identifying, by the first computer, a courier by crowdsourcing a plurality of couriers and based on the determined delivery method; transferring, by the first computer, the token to a computer of the identified courier; updating, by the computer of the identified courier, the token when the order is delivered by the identifier courier; and paying, by the first computer, the identified courier when the delivery of the order is confirmed. Transactions in each step are stored by the corresponding computers into a blockchain; the blockchain is updated at each step by the corresponding computers; and the blockchain is stored on each of the corresponding computers.

A system for crowdsourced delivery is provided. The system includes a first computer configured to: generate an order for a customer based on a profile of the customer, wherein the profile of the customer is stored on a second computer, and the first computer communicates with the second computer to retrieve the profile of the customer; receive warranty data for the order from a computer of manufacturer of the order; associate the order with the warranty data; receive a token for the customer from the computer of the manufacturer of the order, wherein the token for the customer is generated by the computer of the manufacturer of the order; send the token to the second computer, wherein the second computer adds the token to the profile of the customer to generate an updated profile of the customer; update the token with the warranty data; determine a delivery method for the order, based on the updated profile of the customer; identify a courier by crowdsourcing a plurality of couriers and based on the determined delivery method; transfer the token to a computer of the identified courier; pay the identified courier when the delivery of the order is confirmed, wherein the computer of the identified courier updates the token when the order is delivered by the identifier courier. Transactions in each step are stored by the corresponding computers into a blockchain; the blockchain is updated at each step by the corresponding computers; and the blockchain is stored on each of the corresponding computers.

A non-transitory computer-readable storage medium configured as disclosed herein can have instructions stored which, when executed by a computing device, cause the computing device to perform operations for crowdsourced delivery which include: generating, by a first computer, an order for a customer based on a profile of the customer, wherein the profile of the customer is stored on a second computer, and the first computer communicates with the second computer to retrieve the profile of the customer; receiving, by the first computer, warranty data for the order from a computer of manufacturer of the order; associating, by the first computer, the order with the warranty data; generating, by the computer of the manufacturer of the order, a token for the customer; receiving, by the first computer, the token for the customer from the computer of the manufacturer of the order; adding, by the second computer, the token to the profile of the customer to generate an updated profile of the customer, wherein the first computer communicates with the second computer to send the token to the second computer; updating, by the first computer, the token with the warranty data; determining, by the first computer, a delivery method for the order, based on the updated profile of the customer; identifying, by the first computer, a courier by crowdsourcing a plurality of couriers and based on the determined delivery method; transferring, by the first computer, the token to a computer of the identified courier; updating, by the computer of the identified courier, the token when the order is delivered by the identifier courier; and paying, by the first computer, the identified courier when the delivery of the order is confirmed. Transactions in each step are stored by the corresponding computers into a blockchain; the blockchain is updated at each step by the corresponding computers; and the blockchain is stored on each of the corresponding computers.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### BRIEF DESCRIPTION OF THE DRAWINGS

FIG. 1 illustrates an exemplary mesh network between a plurality of parties for tracking a product;

FIG. 2 illustrates an exemplary blockchain based on interactions between the plurality of parties;

FIG. 3 illustrates a block diagram of a blockchain-based process for tracking products;

FIG. 4 illustrates a block diagram of a blockchain-based process for tracking delivery of products;

FIG. 5 illustrates a block diagram of a blockchain-based process for paying a courier via digital currency;

FIG. 6 illustrates a block diagram of a blockchain-based process for identifying a courier;

FIG. 7 illustrates a block diagram of a blockchain-based process for identifying various types of couriers;

FIG. 8 illustrate an exemplary method of tracking a product based on blockchain; and

FIG. 9 illustrates an exemplary computer system.

### DETAILED DESCRIPTION

Systems, methods, and computer-readable storage media configured according to this disclosure are capable of tracking a product in a supply chain based on a blockchain. By using blockchain to track a product, access to information can be decentralized that is authentic and whose “chain of title” is irrefutable. The underlying ledger (blockchain) is tamper-evident. No parties can tamper with a transaction after it is recorded to the ledger. If a transaction is changed, a new transaction must be used to reverse the change, and both transactions are then visible. A single and shared ledger can provide one place to go to determine the ownership and status of a product without disputes

In some embodiments, the disclosed method and system can be used for crowdsourced delivery of products through virtual currency. In such cases, customers can pay using virtual currency. Sellers can be paid through virtual currency. Couriers can be paid through virtual currency. Retailers can be paid through virtual currency. Benefits of virtual currency used in a crowdsourced model for delivery can include, but are not limited to: more feasible for micro processing of payments—those payments usually too small to process through traditional NFC transaction systems; security of the individual's identity on all ends, as well as the courier; identity protection; and open source system for seeing the transactional processing as well as the delivery process. Thus, all parties involved can track the delivery package throughout its delivery life. Since banks are decentralized from the system and their assumed charges may be null, the costs associated with the disclosed system can be significantly less than traditional systems. Embodiments of the invention may provide real-time tracking as the product goes from sale, to delivery, to courier, to customer with an updated hash system. The hash system routinely updates throughout this process.

In some embodiments, the disclosed system and method can include recording warranty information along with a product sale token. Also, a courier can be a human being or an automated vehicle.

In some embodiments, the disclosed system may use a physical key fob to authenticate and wirelessly communicate. The courier can use the key fob to indicate their authenticity. The key fob may communicate wirelessly with a courier's smart device and a customer's smart device. The courier's smart device can communicate with the customer's smart device to initiate a transaction and to add a new block to the blockchain ledger. For added security, the key fob may communicate information, such as the MAC address, from both the courier's smart device and the customer's smart device to the blockchain ledger. Audit functions may be included in the blockchain system to periodically verify courier authenticity and rating.

In some embodiments, the courier may also use the key fob while shopping or picking up items for the customer. The courier can scan items on the shopping list into their smart device. If the system finds they match the customer's shopping list, the system can add the item to the blockchain and authorize payment to the store. In some embodiments, the customer can also have a key fob to streamline transactions. The fob can communicate using low power Bluetooth, WIFI, NFC or other RF communication means.

In some embodiments, a low power version of the key fob may be adhered to the package being delivered. This version of key fob may operate to track important or expensive items. The fob can communicate GPS coordinates to the couriers' smart device periodically. These time and location coordinates may be added to the blockchain ledger. The disclosed system can push notifications to the customer regarding the upcoming delivery.

In some embodiments, if a peer-to-peer network is permissioned, it can enable the creation of a parties-only network with proof that parties are who they say they are. This may protect the system against tampering, fraud, and cybercrime.

In some embodiments, through the use of IDs and permissions, parties can specify which transaction details they want other parties to be permitted to view. Permissions can be expanded for special party. For example, to verify a product, a customer may be authorized to access all the transaction documents of all the parties.

In some embodiments, permissions and cryptography may be used to prevent unauthorized access to the peer-to-peer network and ensure that parties are who they claim to be. Privacy can be maintained through cryptographic techniques and data partitioning techniques to give parties selective visibility into the ledger; both the transaction documents and the identity of parties who own the transaction documents can be masked. After conditions are agreed to, parties can't tamper with a record of the transactions.

In some configurations, communications between the devices can take the form of a blockchain, where each request and response made by devices can be added to the blockchain ledger. As any device takes an action (sending a request, sending a response to a request), that information is added to the blockchain. More specifically, the request, response, or other action is hashed into the previous blockchain. This new, updated blockchain is then distributed to the other devices within the group.

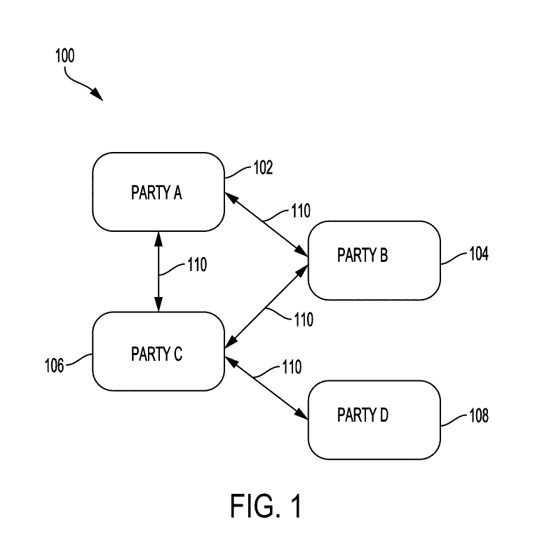

Various specific embodiments of the disclosure are described in detail below. While specific implementations are described, it should be understood that this is done for illustration purposes only. Other components and configurations may be used without parting from the spirit and scope of the disclosure, and can be implemented in combinations of the variations provided. These variations shall be described herein as the various embodiments are set forth. The disclosure now turns to FIG. 1.

FIG. 1 illustrates an exemplary peer-to-peer network 100 between a pluralities of parties 102, 104, 106, 108 who may involve transactions of a product. A peer-to-peer network such as that illustrated is a network where each node can relay data from and to other nodes within the network. While peer-to-peer networks can be constructed to operate in wired conditions, they are more prevalent in wireless configurations, where messages can be broadcast to other nearby nodes (i.e., not sent to a specific node, but rather all nodes within a given distance of the broadcasting node). When a receiving node is located outside the broadcast range of a transmitting node, intermediate nodes may be required to route the transmission to the receiving node. For example, as illustrated, node A (party A) 102 can communicate 110 with nodes B (party B) 104 and C (party C) 106, and nodes B 104 and C 106 can communicate 110 with each other. However, nodes A 102 and B 104 cannot communicate with node D (party D) 108. Because node D 108 can only communicate with node C 106, any communications 110 between node A 102 and node D 108, or between node B 104 and node D 108, must route through node C 106.

When transferring a product, for example, from a manufacturer to a retailer, dealer, or customer, the various parties may communicate with one another via a peer-to-peer network 100. That is, the various parties may use devices at each node to transmit, receive, and relay messages between themselves as necessary. The devices used by the various parties may include, but not limited to, mobile phones, computing tablets, desktop computers, servers, laptop computers, smart phones, mainframes, and so forth.

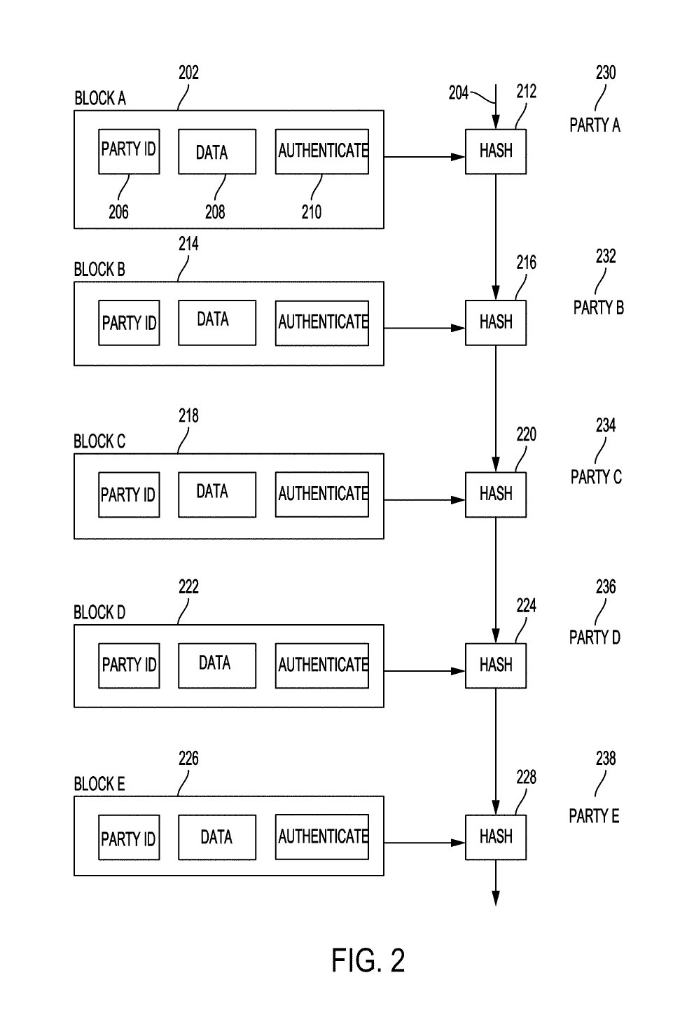

FIG. 2 illustrates an exemplary blockchain based on interactions between a pluralities of parties for transferring a product using the network 100 of FIG. 1. A blockchain is a distributed digital ledger which is communicated electronically between the devices. Each transaction recorded within the digital ledger is a block which can be hashed or otherwise encrypted. As new transactions are added to the digital ledger, each transaction's veracity can be tested against the previous ledger stored by the devices, and can, in some configurations, require confirmation from a defined percentage (usually 50%) of the devices to be added to the blockchain.

In the case of transferring a product, the blockchain can take the form illustrated in FIG. 2. In this example, there is a blockchain 204 which is distributed among multiple devices. One of the devices, an initiating device (party A 230, a manufacturer of the product), determines to transfer the product to a whole sale dealer (party C 234) via a courier (party B 232), and may store transaction data and product data (e.g., product specification, warranty information, handling requirement, terms and conditions, etc.) documents in a block of the blockchain 204. In this example, a block (Block A 202) is generated to store the data documents and related data of party A 230. The block 202 added to the blockchain 204 may contains an ID 206 of party A 230, or an address or identification of a device that may be used by the party A 230, and the data 208. In addition, the block 202 can contain an authentication 210 portion. The authentication 210 portion may set restrictions of different levels on the data 208 and the party ID 206. For example, the data 208 and the party ID may be set not to be visible or accessible to other parties other than party A. The authentication 210 may authorize other parties to view partial portion or details of the documents 208 and the party ID, for example, the title of a document. In addition, the authentication 210 may authorize a full access to the data 208 to a special party or participant, for verifying the product. The data 208 may be encrypted.

The data 208 may also be part of a smart contract, which is an agreement or set of rules that govern how the product is transferred among parties. The smart contract is stored on the blockchain and is executed automatically as part of a transaction.

As the device generates the block 202, the block 202 is hashed 212 into the previous blockchain 204, resulting in an updated blockchain which is distributed among the devices in the group.

The other devices receive the updated blockchain containing the block 202. Party B 232 as a courier may transport the product from party A to Party C. In this case, party B 232 generate a block 214 to store their data related to transportation in the blockchain 204. Similar to block 202, block 214 may store the related transaction data of party B 232, an ID of party B 232, or an address or identification of a device that may be used by the party B 232, and an authentication portion. In addition, party B 232 may monitor the product while in route according to the supply chain requirements of the product, and accordingly log those monitored data into either the block 214 or a side-chain of the blockchain 204.

As the device generates the block 214, the block 214 is hashed 216 into the previous blockchain 204, resulting in an updated blockchain which is distributed among the devices in the group

Party C 234 as a whole dealer may generate block 218 accordingly when receiving the product from party B 232 and hashed into the blockchain 204, resulting in an updated blockchain which is then distributed among the parties in the group.

In some cases, the whole dealer party C 234 may transfer the product to a local seller party E via another courier party D. Accordingly, similar to parties A and B, parties D and E generate corresponding blocks that are hashed into the blockchain 204, resulting in an updated blockchain which is then distributed among the parties in the group.

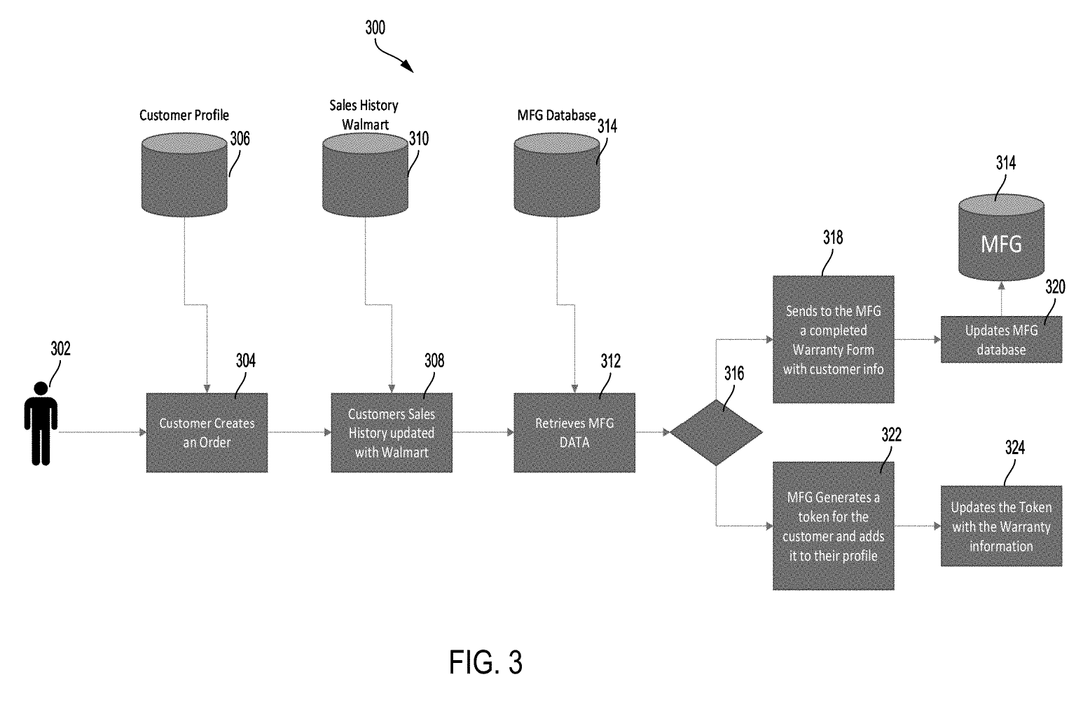

FIG. 3 illustrates a block diagram of a blockchain-based process 300 for transferring a product. In this example, a blockchain platform may be used to store and secure the transactions from each participating parties. One or more products may be transferred from a first party to a second party (for example, from a manufacturer to a retailer) via a courier. A customer 302 may create an order 304. For example, the customer 302 may log into a retailer website by retrieving the customer profile from a database 306 of the retailer and generating the order that may include one or more products. This transaction and associated data may be hashed and stored into a block of a blockchain.

The retailer may update the customer's sale history 308 by including information of the order, and store such updated history in a database 310 of the retailer. This transaction and associated data may be hashed and stored into a block of the blockchain.

The disclosed system may automatically retrieve manufacturer's data 312 for the products in the order, from a manufacturer (MFG) database 314. The manufacturer's data may include, but not limited to, warranty information, terms and conditions of using the products, etc. Those data can be auto-populated in a form, such as a warranty form, and be associated with the order and the customer's profile. This transaction and associated data may be hashed and stored into a block of the blockchain.

In block 316, choices may be made. For example, the completed warranty information form may be sent along with the customer information to the manufacturer (block 318). The manufacturer's database 314 can be updated with the completed warranty information form and the customer information (block 320). This transaction and associated data may be hashed and stored into a block of the blockchain.

In some embodiments, the manufacture may generate a token for the customer and add the token to the customer's profile (block 322). As used herein, the token may be an electronic token or a physical token (e.g., a key fob) that contains the order information, the customer information, and other information. This transaction and associated data may be hashed and stored into a block of the blockchain.

The token may further be updated with the warranty information (block 324). That is, the warranty information may be included in the token. This transaction and associated data may be hashed and stored into a block of the blockchain.

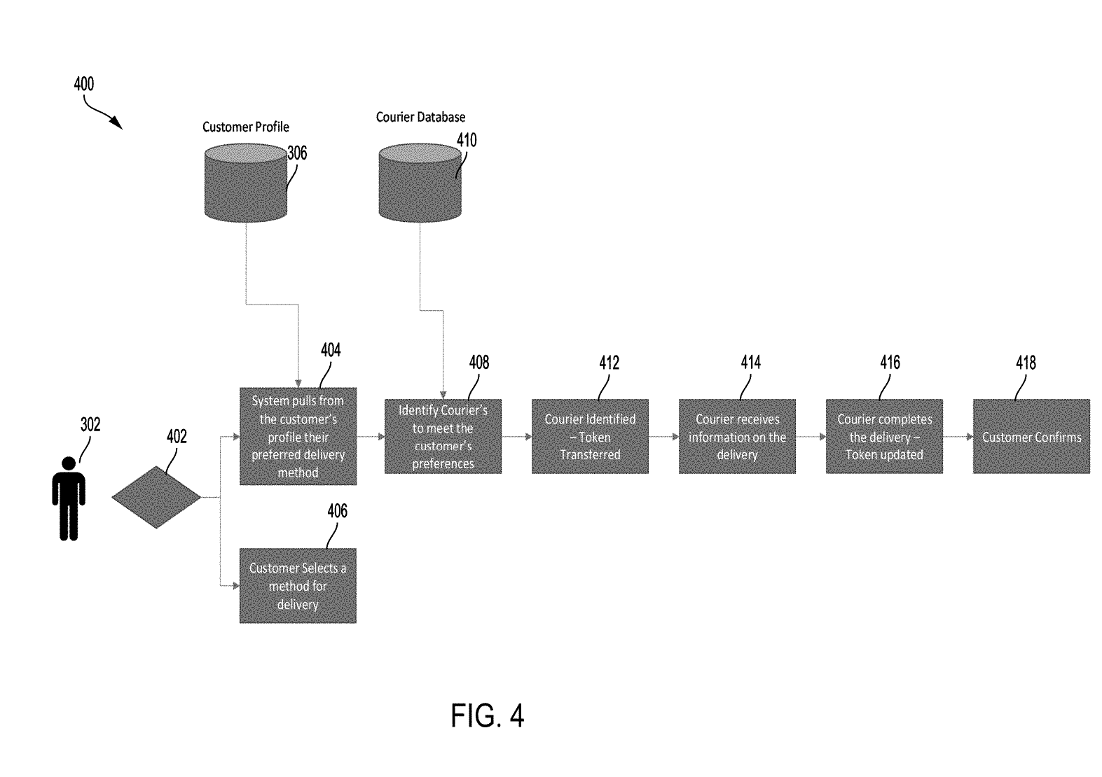

In some embodiments, the order may be delivered to the customer via a courier. FIG. 4 illustrates a block diagram 400 of a blockchain-based process for tracking delivery of products. For the product delivery, the customer 302 may make a decision 402 as to what delivery method will be used. The customer may allow the system to pull from the customer's profile database 306 their preferred delivery method 404. The customer may also select a method for delivery (block 406). These transactions and associated data may be hashed and stored into blocks of the blockchain.

Once a delivery method is determined, a courier may be identified (block 408) from a courier database 410 to meet the customer's preferences. This transaction and associated data may be hashed and stored into a block of the blockchain

After the courier is identified, the token may be transferred to the courier (block 412). The identified courier may also receive information on the delivery including the order information and the customer profile (block 414). These transactions and associated data may be hashed and stored into blocks of the blockchain.

In block 416, the courier completes the delivery and may also update the token to indicate that the delivery has been completed. The customer may also confirm the delivery (block 418). These transactions and associated data may be hashed and stored into blocks of the blockchain.

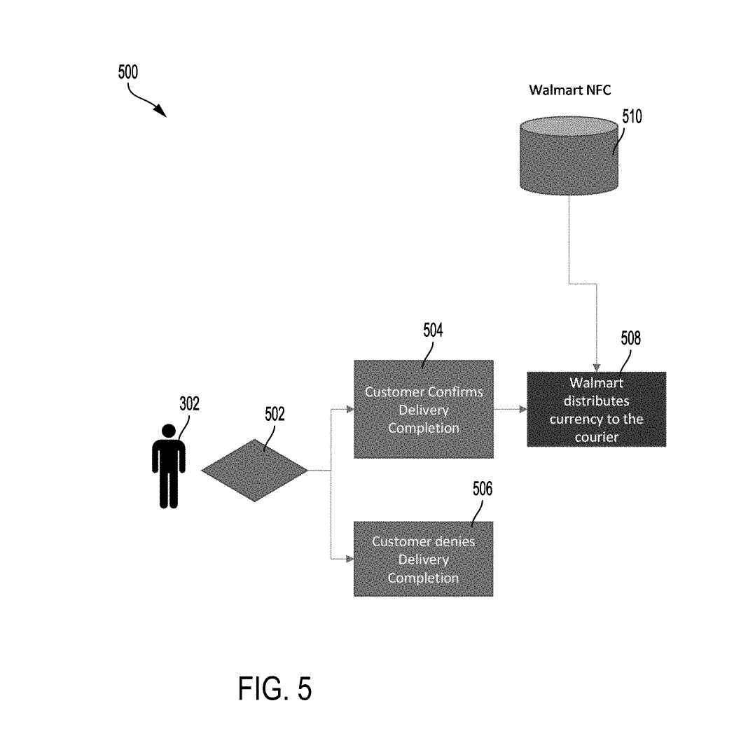

In some embodiments, the customer may also either confirm the delivery or deny the delivery, as shown in FIG. 5. FIG. 5 illustrates a block diagram 500 of a blockchain-based process for paying a courier via digital currency. The customer 302 may make a decision 502, based on, for example, the transactions stored in the blockchain, to deny the delivery (block 506). In a case where the customer confirms the delivery 504, the retailer may pay the courier via virtual/digital currency (block 508), for example by the retailer's nation finance center (NFC) 510.

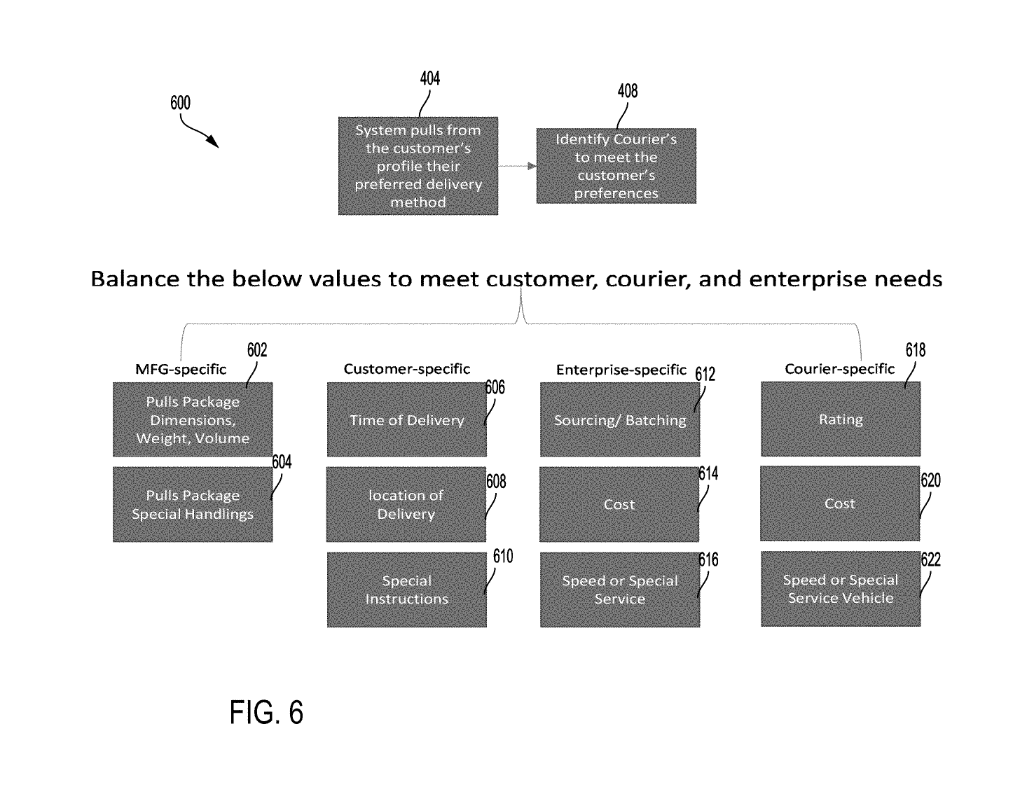

FIG. 6 illustrates a block diagram 600 of a blockchain-based process for identifying a courier. When a courier is identified, the identification may be based on several factors, such as manufacturer's requirement, customer requirement, enterprise or retailer's requirement, and courier requirement. The manufacturer's requirement may include package dimensions, package weight, and package volume (602). The manufacturer's requirement may also include special package handling 604.

The customer requirement may include time of delivery 606, location of delivery 608, special instructions of the customer 610 (e.g., place the package on a mat near the house door), and other requirements.

The enterprise requirements may include sourcing/batching 612. The sourcing may refer to where the products of the order are located, and whether the courier can pick up those products from different locations. The batching may refer to whether those products can be delivery together or separately, and whether the courier is capable of meeting this requirements. The enterprise requirement may also include a cost 614 (e.g., the maximum cost the enterprise can offer to a courier). The enterprise requirement may also include delivery timelines or special service 616. For example, the enterprise may require a courier to be capable of delivering a temperature-controlled (cold) product, a fragile product, or a heavy product.

The courier requirement may include courier rating 618 (e.g., how good the courier is), cost 620 (how much the courier charge for deliveries), and speed or special service vehicle 622 (e.g., how fast the courier can deliver, and does the courier have special service vehicles).

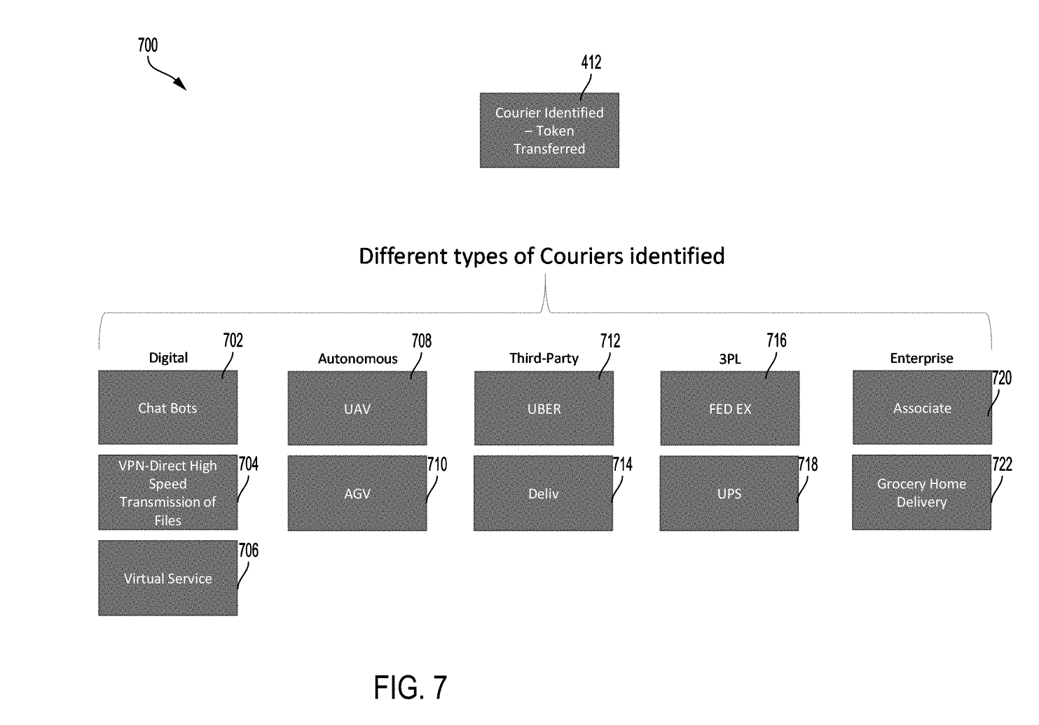

FIG. 7 illustrates a block diagram 700 of a blockchain-based process for identifying various types of couriers. The courier can be in any suitable form, and may include, but not limited to, digital couriers, autonomous couriers, third-party couriers, third-party logistics, and enterprises.

The digital couriers can include chat bots 702, virtual private network (VPN) high speed transmission of files 704, and virtual service 706.

The autonomous courier may include unmanned aerial vehicles 708(UAVs, such as drones), and automated guided vehicles 710.

The third-party courier can include Uber 712, Deliv 714, etc. The third-party logistics may include FedEx 716, and UPS 718.

The enterprise courier may include their store associates 720, and grocery home delivery 722.

In some embodiments, the transaction data documents may be encrypted so the party loading the documents into the blockchain has a private key. The party may provide its private key so that a dealer or buyer can have a full access to the transactions documents and is able to decrypt all the transaction information to do the comparison and analysis.

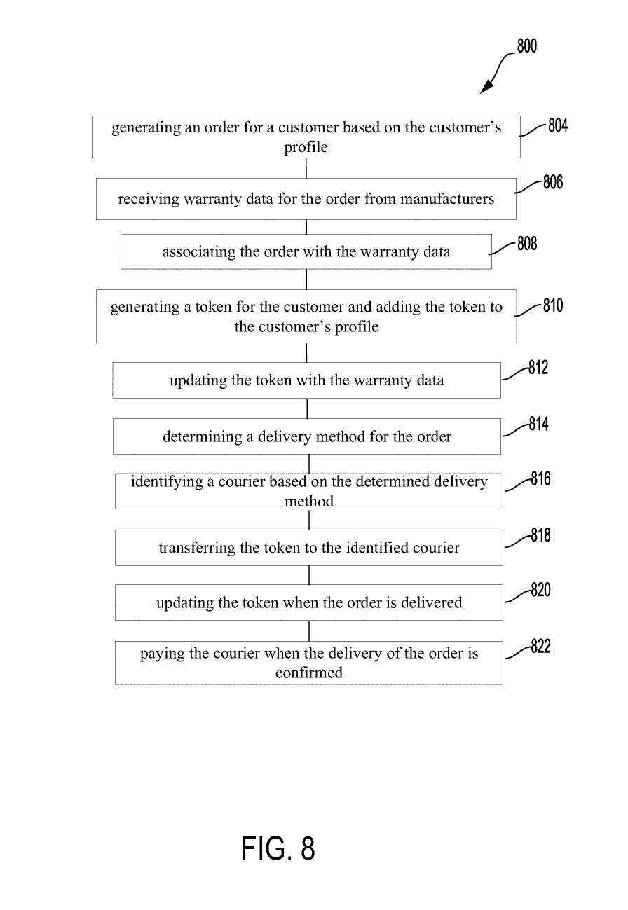

FIG. 8 illustrate an exemplary method 800 of tracking a product based on blockchain. The method 800 may be implemented in the above disclosed systems, may include the following steps.

At step 804, an order may be created by a computer (e.g., a retailer's computer) for a customer based on the customer's profile. For example, when a customer places an order online by logging into an online account of the customer, the order can be generated for the customer based on the customers profile saved online. The profile of the customer may be stored on a computer server of the retailer, and the computer generating the order may communicate with the computer server to retrieve the profile of the customer.

At step 806, warranty data for the order may be received from manufactures of the order. The order may include one or more products that may be provided by different manufacturers. The computer generating the order may receive the warranty data for the order from a computer of manufacturer of the order.

At step 808, the order is associated with the warranty data by the computer generating the order. For example, the warranty data may be automatically filled out on the computer generating the order for the products of the order and saved back to the manufacturers along with the products information and the customer's information on the computer of the manufacturer.

At step 810, a token for the customer may be generated by the computer of the manufacturer and added to the customer's profile by the computer generating the order. The token may contain the order information and the customer information for authentication and delivery. The computer generating the order may receive the token for the customer from the computer of the manufacturer of the order. The computer generating the order may further send the token to the computer server. The computer server may add the token to the profile of the customer to generate an updated profile of the customer.

At step 812, the token may be updated with the warranty data by the computer generating the order. As such, the token may further include the warranty data associated with the products of the order.

At step 814, a delivery method for the order may be determined based on the updated profile of the customer by the computer generating the order. The customer can select a method for delivery via the computer generating the order. The disclosed system may also determine a delivery method based on the customer's history or preferences specified in the customer's profile

At step 816, a courier can be identified based on the determined delivery method and by crowdsourcing a plurality of couriers. The plurality of couriers may be stored in a courier database. Various factors may be considered to identify a suitable courier, such as delivery cost and time, special handling requirement, courier rating and capability, etc. Identification of the courier may also be based on at least one of: the manufacturers' requirements, the customer's requirements, the courier's requirements, and the enterprise's requirements.

The courier can be a human being or an autonomous vehicle. The courier can include at least one of: a digital courier, an autonomous courier, a third-party courier, a third-party logistics courier, and an enterprise.

At step 818, the token is transferred to a computer of the identified courier by the computer generating the order. Once the courier is identified, the token may be transferred to the computer of the courier such that the courier can receive the order information and delivery information, as well as for authenticating the courier.

At step 820, the token is updated by the computer of the identified courier when the order is delivered by the identified courier. When the order is successfully delivered, the token may be updated to reflect the completion of the delivery.

At step 822, the courier may be paid via the computer generating the order when the delivery of the order is confirmed. When the customer confirms the delivery, the system may automatically pay the courier via virtual or digital currency.

All transactions and associated data in each step may be stored via the corresponding computers in blocks of a blockchain, such that the delivery process can be tracked without disputes. The blockchain may be updated at each step by the corresponding computers. The blockchain may be stored on each of the corresponding computers.

In some embodiments, the method 800 may further comprise updating the customer's sale history based on the order by the computer generating the order.

In some embodiments, the method 800 may further comprise: sending to the computer of the manufacturers a completed warranty form with the customer's information by the computer generating the order; and updating manufactures' database based on the completed warranty form by the computer of the manufacturer.

In some embodiments, the token may be a physical key fob that is capable of communicating with the blockchain.

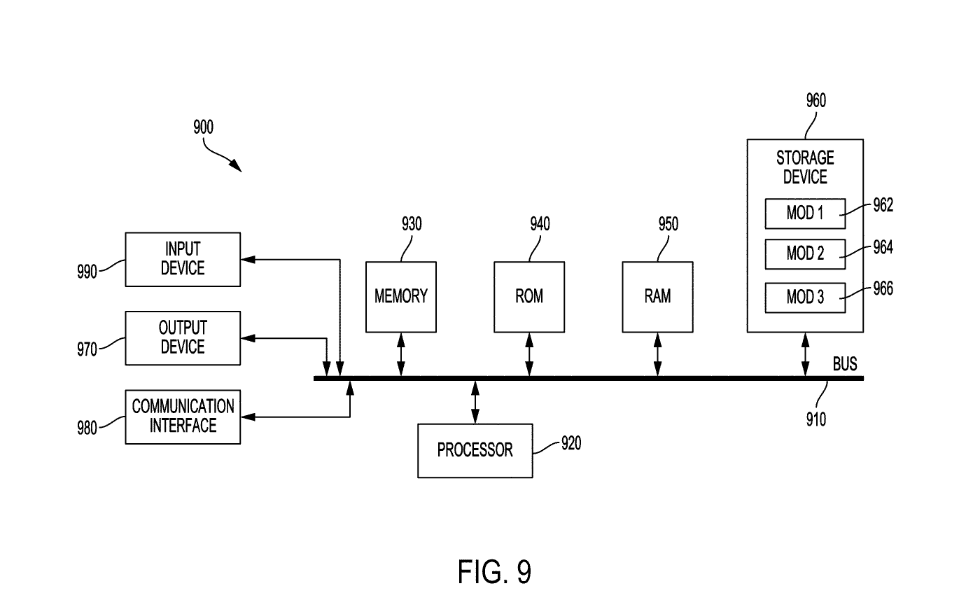

With reference to FIG. 9, an exemplary system 900 can include a processing unit (CPU or processor) 920 and a system bus 910 that couples various system components including the system memory 930 such as read only memory (ROM) 940 and random access memory (RAM) 950 to the processor 920. The system 900 can include a cache of high speed memory connected directly with, in close proximity to, or integrated as part of the processor 920. The system 900 copies data from the memory 930 and/or the storage device 960 to the cache for quick access by the processor 920. In this way, the cache provides a performance boost that avoids processor 920 delays while waiting for data. These and other modules can control or be configured to control the processor 920 to perform various actions. Other system memory 930 may be available for use as well. The memory 930 can include multiple different types of memory with different performance characteristics. It can be appreciated that the disclosure may operate on a computing device 900 with more than one processor 920 or on a group or cluster of computing devices networked together to provide greater processing capability. The processor 920 can include any general purpose processor and a hardware module or software module, such as module 1 962, module 2 964, and module 3 966 stored in storage device 960, configured to control the processor 920 as well as a special-purpose processor where software instructions are incorporated into the actual processor design. The processor 920 may essentially be a completely self-contained computing system, containing multiple cores or processors, a bus, memory controller, cache, etc. A multi-core processor may be symmetric or asymmetric.

The system bus 910 may be any of several types of bus structures including a memory bus or memory controller, a peripheral bus, and a local bus using any of a variety of bus architectures. A basic input/output (BIOS) stored in ROM 940 or the like, may provide the basic routine that helps to transfer information between elements within the computing device 900, such as during start-up. The computing device 900 further includes storage devices 960 such as a hard disk drive, a magnetic disk drive, an optical disk drive, tape drive or the like. The storage device 960 can include software modules 962, 964, 966 for controlling the processor 920. Other hardware or software modules are contemplated. The storage device 960 is connected to the system bus 910 by a drive interface. The drives and the associated computer-readable storage media provide nonvolatile storage of computer-readable instructions, data structures, program modules and other data for the computing device 900. In one aspect, a hardware module that performs a particular function includes the software component stored in a tangible computer-readable storage medium in connection with the necessary hardware components, such as the processor 920, bus 910, display 970, and so forth, to carry out the function. In another aspect, the system can use a processor and computer-readable storage medium to store instructions which, when executed by the processor, cause the processor to perform a method or other specific actions. The basic components and appropriate variations are contemplated depending on the type of device, such as whether the device 900 is a small, handheld computing device, a desktop computer, or a computer server.

Although the exemplary embodiment described herein employs the hard disk 960, other types of computer-readable media which can store data that are accessible by a computer, such as magnetic cassettes, flash memory cards, digital versatile disks, cartridges, random access memories (RAMs) 950, and read only memory (ROM) 940, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with the computing device 900, an input device 990 represents any number of input mechanisms, such as a microphone for speech, a touch-sensitive screen for gesture or graphical input, keyboard, mouse, motion input, speech and so forth. An output device 970 can also be one or more of a number of output mechanisms known to those of skill in the art. In some instances, multimodal systems enable a user to provide multiple types of input to communicate with the computing device 900. The communications interface 980 generally governs and manages the user input and system output. There is no restriction on operating on any particular hardware arrangement and therefore the basic features here may easily be substituted for improved hardware or firmware arrangements as they are developed.

The various embodiments described above are provided by way of illustration only and should not be construed to limit the scope of the disclosure. Various modifications and changes may be made to the principles described herein without following the example embodiments and applications illustrated and described herein, and without departing from the spirit and scope of the disclosure.

1. A blockchain-based method for crowdsourced delivery, comprising:
generating, by a first computer, an order for a customer based on a profile of the customer, wherein the profile of the customer is stored on a second computer, and the first computer communicates with the second computer to retrieve the profile of the customer;
receiving, by the first computer, warranty data for the order from a computer of a manufacturer of the order;
associating, by the first computer, the order with the warranty data;
generating, by the computer of the manufacturer of the order, a token for the customer;
receiving, by the first computer, the token for the customer from the computer of the manufacturer of the order;
adding, by the second computer, the token to the profile of the customer to generate an updated profile of the customer, wherein the first computer communicates with the second computer to send the token to the second computer;
updating, by the first computer, the token with the warranty data;
determining, by the first computer, a delivery method for the order, based on the updated profile of the customer;
identifying, by the first computer, a courier by crowdsourcing a plurality of couriers and based on the determined delivery method;
transferring, by the first computer, the token to a computer of the identified courier;
updating, by the computer of the identified courier, the token when the order is delivered by the identifier courier; and
paying, by the first computer, the identified courier when the delivery of the order is confirmed,
wherein:
transactions in each step are stored by the corresponding computers into a blockchain;
the blockchain is updated at each step by the corresponding computers; and
the blockchain is stored on each of the corresponding computers.

2. The method of claim 1, further comprising:
updating, by the first computer, a sale history of the customer based on the order.

3. The method of claim 1, further comprising:
sending, by the first computer, to the computer of the manufacturer a completed warranty form with the customer's information; and
updating, by the computer of the manufacturer, a manufacture database based on the completed warranty form.

4. The method of claim 1, wherein the delivery method is a preferred delivery method stored in the profile of the customer.

5. The method of claim 1, wherein the delivery method is a delivery method selected via the first computer by the customer.

6. The method of claim 1, wherein the plurality of couriers include at least one of: a digital courier, an autonomous courier, a third-party courier, a third-party logistics courier, and an enterprise.

7. The method of claim 1, wherein the identifying the courier is based on at least one of; the manufacturer's requirements, the customer's requirements, the courier's requirements, and the enterprise's requirements.

8. The method of claim 1, wherein the token is a physical key fob.

9. The method of claim 8, wherein the key fob is capable of communicating with the blockchain.

10. A system for crowdsourced delivery, comprising:
a first computer configured to:
generate an order for a customer based on a profile of the customer, wherein the profile of the customer is stored on a second computer, and the first computer communicates with the second computer to retrieve the profile of the customer;
receive warranty data for the order from a computer of a manufacturer of the order;
associate the order with the warranty data;
receive a token for the customer from the computer of the manufacturer of the order, wherein the token for the customer is generated by the computer of the manufacturer of the order;
send the token to the second computer, wherein the second computer adds the token to the profile of the customer to generate an updated profile of the customer;
update the token with the warranty data;
determine a delivery method for the order, based on the updated profile of the customer;
identify a courier by crowdsourcing a plurality of couriers and based on the determined delivery method;
transfer the token to a computer of the identified courier;
pay the identified courier when the delivery of the order is confirmed, wherein the computer of the identified courier updates the token when the order is delivered by the identifier courier,
wherein:
transactions in each step are stored by the corresponding computers into a blockchain;
the blockchain is updated at each step by the corresponding computers; and
the blockchain is stored on each of the corresponding computers.

11. The system of claim 10, wherein the first computer is further configured to update a sale history of the customer based on the order.

12. The system of claim 10, wherein the first computer is further configured to send to the computer of the manufacturer a completed warranty form with the customer's information, wherein the computer of the manufacturer updates a manufacture database based on the completed warranty form.

13. The system of claim 10, wherein the delivery method is a preferred delivery method stored in the profile of the customer.

14. The system of claim 10, wherein the delivery method is a delivery method selected via the first computer by the customer.

15. The system of claim 10, wherein the plurality of couriers include at least one of: a digital courier, an autonomous courier, a third-party courier, a third-party logistics courier, and an enterprise.

16. The system of claim 10, wherein the identifying the courier is based on at least one of the manufacturer's requirements, the customer's requirements, the courier's requirements, and the enterprise's requirements.

17. The system of claim 10, wherein the token is a physical key fob.

18. The system of claim 17, wherein the key fob is capable of communicating with the blockchain.

19. A non-transitory computer-readable storage medium having instructions stored which, when executed by a computing device, cause the computing device to perform operations comprising:
generating, by a first computer, an order for a customer based on a profile of the customer, wherein the profile of the customer is stored on a second computer, and the first computer communicates with the second computer to retrieve the profile of the customer;
receiving, by the first computer, warranty data for the order from a computer of a manufacturer of the order;
associating, by the first computer, the order with the warranty data;
generating, by the computer of the manufacturer of the order, a token for the customer;
receiving, by the first computer, the token for the customer from the computer of the manufacturer of the order;
adding, by the second computer, the token to the profile of the customer to generate an updated profile of the customer, wherein the first computer communicates with the second computer to send the token to the second computer;
updating, by the first computer, the token with the warranty data;
determining, by the first computer, a delivery method for the order, based on the updated profile of the customer;
identifying, by the first computer, a courier by crowdsourcing a plurality of couriers and based on the determined delivery method;
transferring, by the first computer, the token to a computer of the identified courier;
updating, by the computer of the identified courier, the token when the order is delivered by the identifier courier; and
paying, by the first computer, the identified courier when the delivery of the order is confirmed,
wherein:
transactions in each step are stored by the corresponding computers into a blockchain;
the blockchain is updated at each step by the corresponding computers; and
the blockchain is stored on each of the corresponding computers.

20. The computer-readable medium of claim 19, further having further instructions stored which, when executed by the processor, cause the processor to perform operations:
updating, by the first computer, a sale history of the customer based on the order.
